(19) United States
(12) Patent Application Publication
(10) Pub. No.: US 2001/0016825 A1
(43) Pub. Date: Aug. 23, 2001

(54) Electronic ticketing and reservation system and method

(76) Inventors: Anthony V. Pugliese, III, Boca Raton, FL (US); Joel R. Goheen, Charlotte, NC (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/828,191

(22) Filed: Apr. 9, 2001

Related U.S. Application Data
(62) Division of application No. 08/987,773, filed on Dec. 9, 1997, now abandoned.
Application No. 08/987,773 is a continuation-in-part of application No. 08/342,658, filed on Nov. 21, 1994, now Pat. No. 5,724,520.
Application No. 08/342,658 is a continuation of application No. 08/074,072, filed on Jun. 8, 1993, now abandoned.

(51) Int. Cl. G06F 17/60

(52) U.S. Cl. 705/5; 235/380

(57) ABSTRACT

A method of and system for issuing an electronic authorization and validation for pre-scheduled activities, such as airline reservations, to eliminate paper tickets. The passenger makes the reservation and a reservation number is issued in the central computer of the airline reservation center. The passenger is then issued a plastic I.D. card that may be used to access the computer for validation purposes. An automatic teller machine, at the airport, allows the passenger to receive specific flight information, departure gate information, and a boarding pass, and to make reservations and access frequent flier information and messages, simply by the insertion of the I.D. card in a card a reader at the ATM. A mobile airline communications system at the departure gate includes a magnetic card reader that provides validation of the reservation at the departure, which allows the passenger to board the aircraft. The system may be utilized for hotel reservations, car rentals and other types of pre-scheduled, pre-payable activities that require authorization and validation at each scheduled activity. Also, goods and services provided by the airline may be obtained using the I.D. card, including charging purchases against the passenger's accumulated frequent flier miles.

### CROSS-REFERENCE TO RELATED APPLICATIONS

This application is a continuation-in-part of U.S. application Ser. No. 342,658, filed Nov. 21, 1994, which is a continuation of U.S. application Ser. No. 074,072, filed Jun. 8, 1993, now abandoned.

### BACKGROUND OF THE INVENTION

The present invention relates to a system and method of providing an electronic reservation and individual validation for various activities, including boarding a common carrier, and more particularly, relates to a method and system to provide an electronic individual activities reservation and validation, eliminating tickets and other paper receipts. A plastic card may also be employed with an encoded magnetic strip or other form of storage medium to identify the card holder in lieu of a paper carbon ticket for fast and efficient check-in, boarding and access to common carriers, car rentals, hotels, and other activities.

Since the first days of common carriers, such as the commercial airlines, the airlines have been burdened with the job of making reservations and writing or printing out passenger tickets on paper. Although the airline ticket of today is printed on a special paper with a style difficult to counterfeit, the reservation and ticketing process has essentially remained the same. A passenger, either through the airline or an independent ticket agent, pays for passage and a corresponding multi-sheet paper ticket is issued. This paper ticket then must be surrendered to authorized agents of the airline at the departure gate to allow the passenger entry onto the aircraft. Likewise, in other industries, such as the hotel industry, the reservations system also includes check-in processing, paperwork, and the issuance of keys to particular individuals traveling.

The fundamental problem is validating that a particular individual has reserved and prepaid for particular activities or services, and that the particular individual continues to be valid throughout an activity process, whether making a reservation for an airline trip, boarding the aircraft, or checking into a hotel and going to a particular room. There are inherent problems in this process. Using the airlines as an example, these include the burdens of making individual reservations and payment, always having to have the correct type and style paper ticket on hand for ticket printing, the possibility that the passenger will forget to bring the ticket when he or she arrives for a flight and the inability for these tickets to be reused if mistakes occur or flight changes are necessary, which happen often.

Further, if a ticket is lost or a passenger forgets the tickets, an added dilemma occurs in that new tickets must be drawn up and the passenger is required to pay once again for the new tickets even though the lost or forgotten tickets had been paid for previously. In this regard, the airline will wait a reasonable time to ensure that the lost or forgotten tickets are not turned in by another individual (typically several months) before issuing a refund on the previous tickets.

Tickets also need to be reissued in the case where a passenger misses a flight. In such a case, although a written record is usually available for the airline and passenger, this process creates an added burden since the airline ticket agent must perform the task of checking and determining the new and previous flight information for each new ticket.

Moreover, a flight attendant or agent at the departure gate must gather and hold each ticket upon passenger boarding. Often, tickets get lost or are mixed with other flights, which requires tedious work and wasted time in locating, interpreting, and arranging the misplaced tickets. Even after tickets are collected at the gate, manual sorting is often necessary to determine which passengers have boarded the correct flight and which flights were at capacity and, therefore, profitable. The final problem comes in the storing of used tickets by the airlines, which represents an enormous expense to the airlines and significantly contributes to their cost of doing business and ultimately to what they must charge the passenger for air travel.

The key problem is validating the reservation and payment of the individual throughout the process without slowing the process at particular check points, such as baggage check-in and aircraft boarding, while, at the same time, eliminating the expense of issuing, handling and storing tickets for this purpose. Similar problems exist in the hotel industry and the car rental industry.

Ticketing systems are known in the prior art. U.S. Pat. No. 4,449,186, issued to Kelly et al. on May 15, 1984, shows a self-ticketing system. However, this system essentially continues the paper problem and is used for vending airline tickets. U.S. Pat. No. 4,298,793, issued to Melis et al. on Nov. 3, 1981, shows a portable element, like a card, that stores and provides reservation system information. None of these systems focus particularly on the problem of validating a particular individual as to the fact that individual reservations have been made, individual payment has been made, and that this individual should be able to traverse through the system without being mired in endless paper and without waiting in lines. With the above problems causing much delay and loss of efficiency due to the amount of clerical work involved in keeping an accurate account of the great numbers of paper tickets issued, the present invention was developed.

### SUMMARY OF THE INVENTION

The present invention is directed to a communication system and method of electronically, continuously validating an individual as to reservations and payment with respect to various preplanned activities, such as airline travel, hotel stays, and car rental. The system connects a main computer system storing basic information to computer terminals, including mobile lap top individual computers, at remote sites in order to exchange personal database validation information for an individual and certain preplanned activities. Reservations and payment information includes both sales control and holder validity at the critical sites. Each computer terminal includes a card reader to expedite pass through of the individual at each process check point.

Using the airlines as an example, the method and system of the present invention now will be described. Typically, the common carrier reservation process starts with a prospective passenger contacting the airline via a travel agent or contacting the airline directly through a toll free 800 telephone number. The airline reservation operator, who answers the call, provides flight availability information. Once the passenger elects to reserve passage, personal information is obtained. This personal information is basically the passenger's personal identification (an I.D. number, if one previously has been issued to this individual, or the individual's name, address, and telephone number) and the form of payment to be used. If a passenger elects to pay by credit card, the airline main computer is designed and includes software to automatically seek and determine authorization from the credit card company. If the passenger desires to make payment using the credit card method, the airline main computer will transfer the funds and store the passenger reservation information and an assigned reservation number. A cash or check payment at a travel agency, once verified, will also result in a reservation number being stored in the main computer.

Upon the first, initial reservation, the passenger is issued a plastic identification card which carries a unique card number. The plastic card is used for passenger identification and validation. The card number only is encoded onto a memory element, such as a magnetic strip at the back of the plastic identification card. The card is mailed to the passenger with an itinerary and instruction pamphlet attached. The instruction pamphlet informs the passenger of the proper use of the identification card upon arrival at the airport. With the itinerary, the airline may include a statement of the required governmental regulations, such as required by Warsaw Pact countries, or such regulations may be printed on the back of the identification card itself. The identification card can be used once or again and again for different flights, since it carries no flight information, but is used only to access the data base of the main computer which stores passenger records. This card may also be color coded to visually identify special categories of travelers, such as airline club members, members of frequent flier programs, travel agents and airline personnel, for example.

At the airport, if the passenger wishes to check baggage at curbside, he or she will proceed to a baggage handling station provided at curbside by the airline and at which there are one or more computer terminals available for use by the baggage handling agents of the airline. The passenger will present his or her card along with a picture ID (as now required for security purposes) to the agent, and the agent will swipe the identification card through the card reader at the computer terminal, causing the identification information stored on the card to be communicated to the central computer where reservation information is stored. On the basis of the received passenger I.D. number, which is stored on the card, the central computer will send to the remote terminal information which identifies the flight number and flight destination (including intermediate stops) along with a verification of the passenger identification (the name of the passenger and accompanying passengers, for example) which will then be verified with the picture ID presented by the passenger and accompanying adult passengers. If the information received from the main computer were to include a current photograph of the person to whom the card has been issued, then the need for the passenger to present a photo I.D. at this time would obviously become unnecessary. Another possibility is to include a picture of the card holder on the card itself, such as now being done on some credit cards. An even more sophisticated approach would involve fingerprint or retina scan recognition to positively identify the passenger.

The baggage agent will then ticket each bag being checked according to the destination, and then enter into the computer terminal information, such as the number of bags being checked and possibly the ticket number on each bag (which can be read quickly by a bar code reader), which information is then stored in the central computer in association with the passenger reservation information. An advantage of this from the standpoint of security is that, when the passenger boards the airplane, information as to the boarding can be similarly stored in the central computer, making it possible for the central computer to determine, even before the flight departs, whether all passengers who have checked bags have boarded the airplane.

If the passenger does not wish to check baggage at curbside when he or she arrives at the airport, he or she may proceed directly to check-in at a special identification card automatic teller machine (ATM), which may be conveniently located at a kiosk on the terminal concourse. One or more of these kiosks are preferably placed throughout a designated airline terminal, each having one or more ATM machines. At the machine, the passenger passes or swipes the identification card through a magnetic card reader attached to the special ATM. The card number stored magnetically or otherwise on the card is identified by the ATM, which is electrically connected to the main or central computer holding the payment and reservation validation information. The remotely located central computer receives the data sent from the ATM and processes the card number derived from the magnetic strip or other storage medium to access main storage.

A greeting, welcome information, and a menu of items are then displayed on a CRT screen and may be selected by the passenger, such as “flight information”, which instructs the passenger as to the proper concourse and gate of aircraft departure. A written printout may be also included showing the information which has been displayed on the CRT screen, as well as a receipt for the ticket charge to the passenger's credit card account, if this was not sent to the passenger previously by the reservation center. The printout is supplied through an attached printer, within the ATM, directly to the passenger. The printout is only to provide relevant information, such as still required by government regulations, as well as regulations based on the Warsaw Convention on liability, and may include a boarding pass; however, neither the printed information, nor the boarding pass, constitute or operate as an airline ticket.

After the passenger's baggage has been checked and he or she has checked in at an ATM and arrives at the departure gate, a flight attendant or agent awaits each passenger before boarding. If the passenger has obtained a boarding pass at a kiosk on the concourse, he or she merely presents the boarding pass to the agent (or merely inserts the boarding pass into an electronic reader) and boards the aircraft. If the passenger has not obtained a boarding pass, the passenger presents his or her identification card to the agent. The agent is provided with a similar computer terminal as that provided for baggage check, or possibly a lap top or notebook type portable computer with a built in cellular telephone and magnetic card reader, hereinafter referred to as a mobile airline communication unit. The passenger identification card, which in this case represents a substitute for a boarding pass, is swiped through the magnetic card reader, and the main or central computer is accessed by the computer terminal or the mobile computer by cellular or standard telephone, and validates the specific card identification number and reservation number and passenger authorization for entry to the aircraft. The airline communication unit is both uploaded and downloaded frequently to the main computer in order to provide a current record in the main computer of updated passenger validation information, such as flight reservations and payment, passenger boarding and flight information and frequent flier mileage information.

The plastic card forms the basis for identification only of the particular individual. The card has a card number (I.D. number or PIN #), encoded magnetically or otherwise stored, that is utilized with the appropriate card reader technology to activate the main computer and provide a subsequent validation or authorization with respect to particular reservations, be it for airlines, hotels or rental cars or the like. The specific reservation information is not put on the card. Once payment has been authorized, for example for airline travel, the main computer has a reservation number that is associated with a particular card number once the card is read and the computer is questioned for authorization of a particular reservation. Therefore, once the particular individual who is also identified by a particular card number has paid for the particular reservation, at each step in the process, such as baggage check-in and boarding at the terminal gate, or at hotel check-in, or when picking up a rental car, inserting the I.D. card into a card reader provides authorization and verification of the reservation and payment, allowing the person to pass through the system continuously without requiring paper at each step of the way.

In fact, the person can pass through the system even if the person loses the card by using the person's name or fingerprint or retina scan recognition, which information again will be transmitted to the main computer that shows that there is an existing reservation number that has been paid for and is authorized. The I.D. card makes it quicker and faster so that the airline personnel at each check point do not have to enter any information to access the main computer, but can merely allow the individual to run the card through a card reader and pass on through.

In the event a passenger misses a flight or requires a flight change, the main computer itself or the airline reservation center office can convert the specific passenger reservation and payment validation to a revised flight reservation. Until the card is read or a boarding pass is presented at the gate during boarding, the card number will indicate in the main computer a valid reservation that can be used on a particular flight. Once the card is magnetically read or a boarding pass is presented by the passenger upon boarding, however, the communication unit uploads the authorization to the main computer, thereby canceling the validation number for that particular flight reservation, and stores an indication that the passenger has boarded. Thus, the main computer can correlate the baggage check information with the passenger boarding information to ensure that every passenger who has checked baggage also has boarded the flight before departure. The identification card and its number continue to identify a particular person, but no particular reservation authorization is listed in the main computer, preventing intentional or unintentional misuse in the future.

The main computer may be large main frame holding passenger and airline flight reservation and payment information under the passenger's name, phone number, reservation number and passenger's card identification number and reservation #. The main frame computer is also capable of retaining passenger flight records for flight bonus programs and frequent flyer mileage totals. If a passenger were to lose his identification card immediately prior to boarding, the flight attendant can access the data bank within the main computer with the card number. This is accomplished by entering a passenger's name or card number manually into the terminal unit keyboard. Proof of identity will then be the only requirement before boarding is permitted. The card is therefore not a requirement for boarding the aircraft.

Therefore, it is the principal object of the invention to provide a method and system of issuing an electronic validation to an individual for reservations and payment for preplanned activities, such as flight reservations, hotel reservations or rental car reservations.

It is a further object of the invention to provide a method of electronic validation to eliminate paper ticketing or paper validation.

It is still a further object of the invention to provide a method of providing personal and accurate up-to-the-minute information for common carrier passengers through the use of an automated teller machine as part of an electronic validation system.

It is still a further object of the invention to provide a method of supplying a passenger with gate and other information, including a printout of his or her itinerary, and possibly a boarding pass using an automated teller system with associated screen and printer without requiring the passenger to present an airline ticket.

It is still a further object of the invention to provide a method of allowing an agent of an airline at a departure gate, using a data communication unit capable of reading magnetically encoded information from an electronic card, to validate an individual passenger's right to board a particular flight without requiring the passenger to present a valid airline ticket.

In accordance with these and other objects which will be apparent hereinafter, the instant invention will now become described with particular reference to the accompanying drawings.

### BRIEF DESCRIPTION OF THE DRAWINGS

FIGS. 1A, and 1B, when combined as indicated in FIG. 1, illustrate a flow chart depicting the method of the present invention.

FIG. 2A illustrates the front side of an identification card of the present invention.

FIG. 2B illustrates the rear side of an identification card shown in FIG. 2A.

FIG. 3 illustrates diagrammatically the system utilized in the present invention, including the general configuration of the main computer, the mobile computer communication unit and card reader and an automated teller machine.

FIG. 4 is a diagram of the display screen in an ATM, showing the menu displayed when a passenger I.D. card is read at the ATM.

FIGS. 4A to 4F are flow diagrams illustrating the processes carried out when a respective item in the menu of FIG. 4 is selected.

FIG. 5 is a diagram of one example of data stored in main memory for each passenger.

FIG. 6 is a diagram of a passenger seat assignment record stored in main storage.

FIG. 7 is a diagram of a seat selection pattern to be used by a passenger in selecting a seat at an ATM.

FIG. 8 is a diagrammatic cross-section of a portion of an airplane cabin showing various features of the invention.

FIG. 9 is a plan view of the back of an airplane seat showing more details of the elements shown in FIG. 8.

### DESCRIPTION OF THE PREFERRED EMBODIMENTS

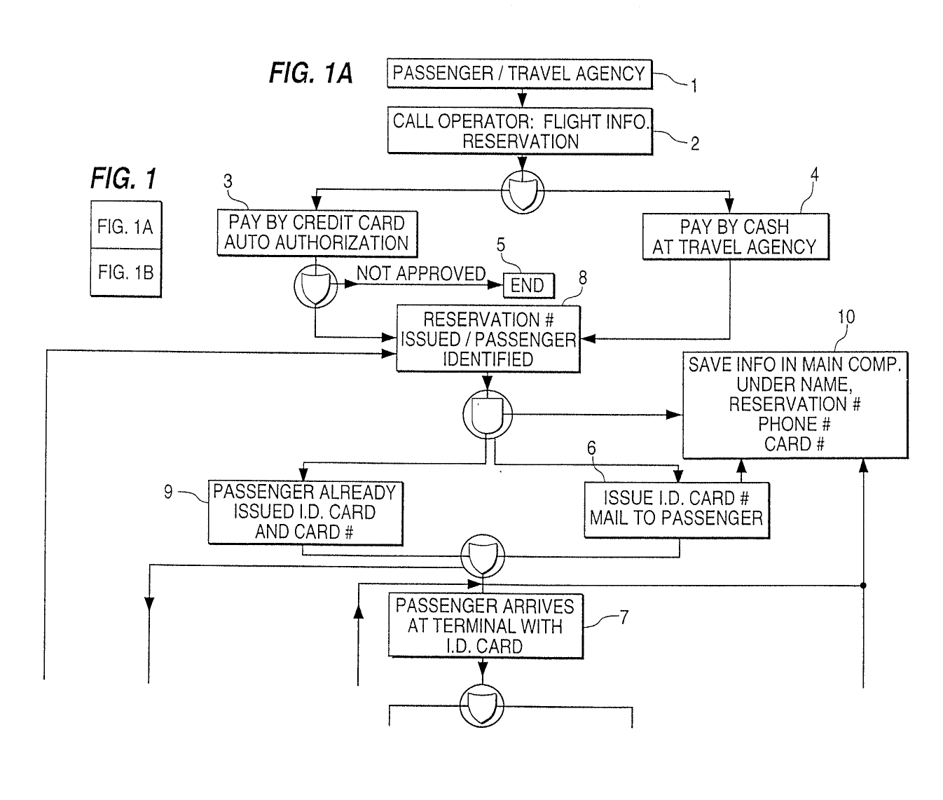

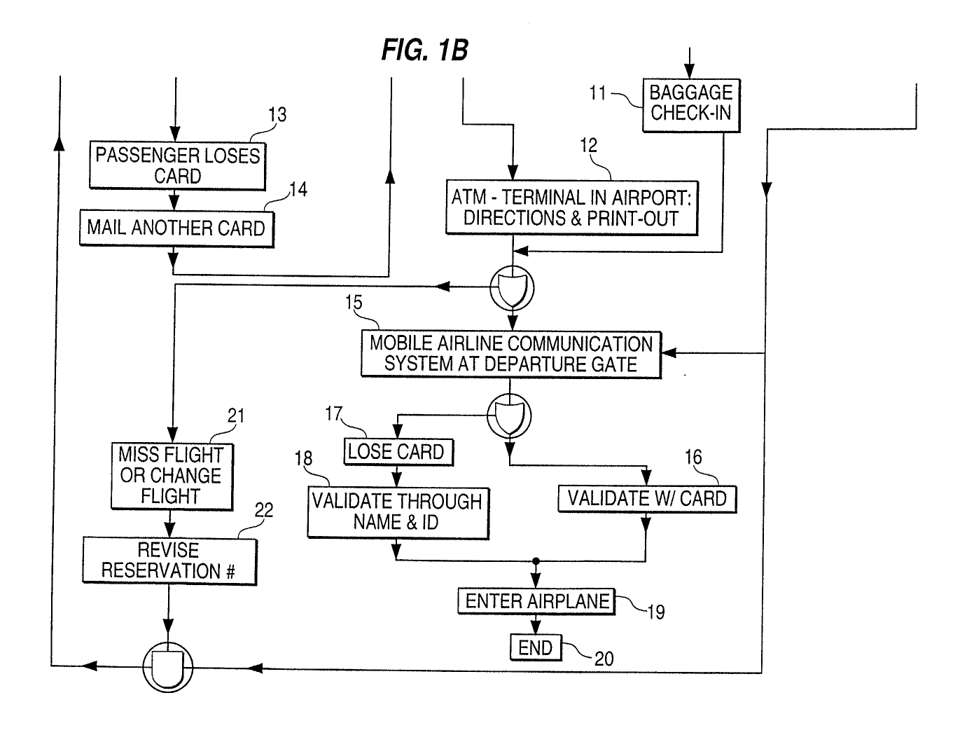

A flow chart of the method describing a system using the instant invention is shown in FIGS. 1A and 1B (when combined as indicated in FIG. 1). An airline reservation is selected as an example. A prospective passenger or travel agent represented by block 1 contacts the airline flight information and reservation center generally via a toll free telephone number at block 2. The flight information reservation center is the central calling point where the airline, or a private company who handles all the reservations and authorizations, operates with a regular telephone network and with call-in access from cellular telephones. A main computer is maintained at or is accessible from the reservation center. Reservations may also be made using an ATM provided by the airline at an airline terminal or at any location remote from an airline terminal, such as a convenient area in a business district of a major metropolitan area, a hotel lobby or an office building.

Once a passenger or the travel agency calls in or otherwise accesses the reservation center via an ATM, flight information is given for available flights to a specified location on a specified date, from which a specific flight is selected. If an individual calls in or uses an ATM, payment is made at block 3 by a credit card account, which is automatically accessed while the passenger is on the telephone line, causing transfer of the payment at that moment to the airline. Credit card payment is verified while the passenger is on line. If the travel agent handles the transaction, then payment must be made by cash or money order at block 4 or by credit card to the travel agent. The travel agency typically will have a relationship with the airline or the reservation center as far as transfer of money is concerned once payment has been made in cash by the passenger. The travel agent is compensated and paid electronically as soon as the main computer completes the transaction. In this regard, information as to the percentage or flat fee to be paid to the travel agent, in accordance with the agreement between the travel agent and the airline, is stored in the main computer for each particular agent or agency, which is identified by a registration number and will be paid accordingly. Obviously, if the credit card authorization is not approved, then the transaction would end at block 5 and no further reservation would be made until payment is verified by the main computer.

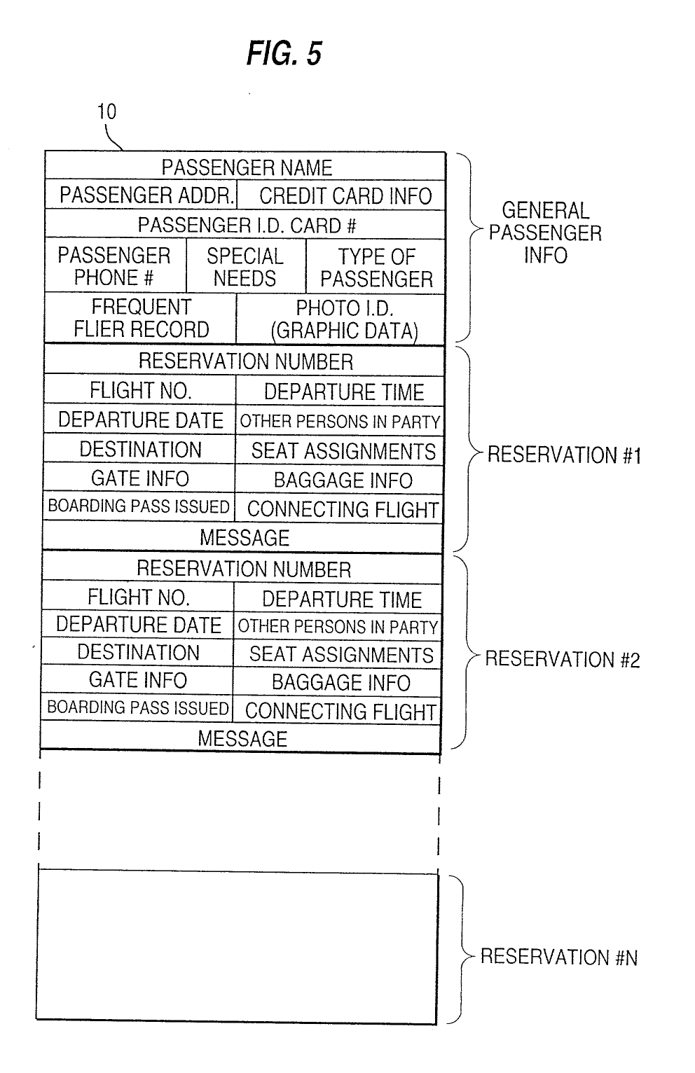

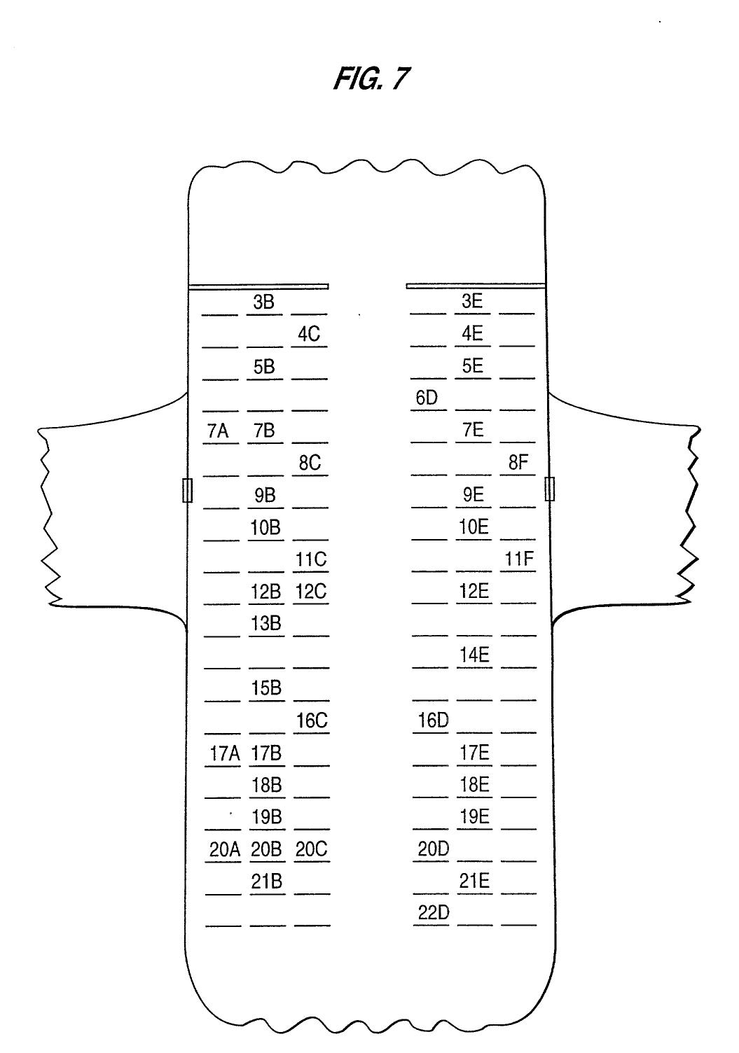

In any event, after authorized payment has been made, a reservation number for a particular flight is then issued in the computer and identified with a particular passenger name and I.D. card number. The reservation number issued at block 8 that identifies the passenger would cause either the issue of a specific plastic I.D. card at block 9, which is mailed to the passenger and has stored thereon only a card I.D. number, or if the passenger already has in his or her possession an identification card and therefore already has an I.D. number, the reservation number is then stored in the main computer records in block 10 under the passenger I.D. card number, along with the flight information, including the flight number (or numbers in the case of connecting flights), the destination, the time and date of departure, the arrival time, the names of accompanying passengers and the seat or seats assigned, if any, as seen in FIG. 5. When any passenger reserves a connecting flight that involves a change in airplanes, or where reservations are made for an itinerary involving several flights over a period of days, the passenger record will store separate reservation information for each flight or leg of a flight.

Where a new card is issued in block 9, a passenger record is set up in the main computer under the newly issued I.D. number, as shown in FIG. 5. This passenger record not only has a field for storing flight information of the type described above, but also a personal profile of the individual passenger, including his or her name, telephone number, current address, typical type of travel (i.e. business, pleasure, frequent flyer, etc.), any special needs (i.e. seating, meals, wheelchair access, reading materials, etc.) special handling that may be required by this passenger, the passenger's frequent flier record and the last flight by the passenger on the particular airline.

The passenger profile stored in main memory may also include graphic data, representing a photograph of the passenger, which graphic data is automatically retrieved at a remote terminal each time a passenger I.D. card is read at that terminal to provide to the airline agent at the terminal a confirming picture of the passenger to whom the card has been issued. This field could also (or in the alternative) include graphic data to be used for fingerprint or retina scan identification. This will avoid the need for a passenger to present a photo I.D. at the time of baggage check-in or at the gate prior to boarding, thereby avoiding ensuing delays.

At this point then, the passenger will have in his or her possession an I.D. card with a number stored on it. The reservation for a particular flight has been stored in the computer and the payment has already been authorized and made to the airline. The passenger then arrives at the airline terminal with the I.D. card at block 7. Referring now to FIG. 1B, when the passenger arrives at the airport terminal, if the passenger wishes to check baggage at curbside, he or she will proceed to a baggage handling station provided at curbside by the airline (block 11) and at which there are one or more remote computer terminals available for use by the baggage handling agents of the airline. The passenger will present his or her card along with a picture ID (as now required for security purposes) to the agent, and the agent will swipe the identification card through the card reader at the computer terminal, causing the identification information stored on the card to be communicated to the central computer where reservation information and the passenger profile is stored. On the basis of the received identification number, the central computer will access the passenger record, find the reservation information field or fields which have a departure date corresponding to the current date, and will send to the remote terminal flight information which identifies the flight number and flight destination (including intermediate stops) for each flight on which the passenger is scheduled for that day, along with a verification of the passenger identification (the names of the passenger and accompanying passengers, for example), which will then be verified with the picture ID presented by the passenger.

Where the profile information includes a photo of the passenger, the need for the passenger to submit a photo I.D. becomes unnecessary and the baggage check-in process will be significantly speeded up. In this regard, in the case of fingerprint identification, the passenger merely places a finger or hand on a scanner, which then sends the detected fingerprint data to the central computer where verification of the identity is carried out on the basis of graphic data stored in the passenger record using known pattern recognition software. Where retina scan equipment is provided at the location, the passenger is asked to look into a detector, and an identification process similar to the above-described fingerprint recognition is carried out. A possibly simpler process of verification of the identity of the card holder would be to provide a chip on the card for storing fingerprint identifying data obtained when the card is issued. Then, when the card is presented, the card holder places his or her hand on a scanner and detected fingerprint data is compared with the fingerprint data stored on the card, thereby verifying that the card holder is the person to whom the card was originally issued. The same process could also employ retina scan identifying data. Card verification would typically be a requisite to accessing the main storage.

The baggage agent will then ticket each bag being checked according to the destination, and then enter into the computer terminal information, such as the number of bags being checked and possibly the ticket number on each bag (which can be read quickly by a bar code reader), which information is then stored in the central computer in association with the passenger reservation information. An advantage of this from the standpoint of security is that, when the passenger boards the airplane, information as to the boarding can be similarly stored in the central computer, making it possible for the central computer to determine, even before the flight departs, whether all passengers who have checked bags have boarded the airplane, as will be discussed in more detail later. The storing of baggage claim numbers in association with the passenger reservation information also makes it easier to identify the owner of lost bags and to track baggage in general.

If the passenger has no bags to check, he or she may then proceed directly into the terminal concourse and enter one of several kiosks for check-in, where there are one or more ATMs 12. The I.D. card is put into a card reader in the ATM, which can provide on a CRT or other type of screen, such as a touch screen, directions and information concerning the flight, including the flight number, the departure time, seat or seats assigned, and what gate to go to for the flight itself. Thus, the passenger does not have to remember the flight information before arriving at the airline terminal, except for the departure date and the approximate departure time necessary to his or her timely arrival at the airport. This information, which is automatically retrieved from the main storage records when the passenger's I.D. card is read by the ATM, can be displayed on a screen only or can be provided also as a print out. In this regard, the ATM provides the passenger with the ability to obtain a print-out of anything displayed on the screen. Further, if the passenger did not make a seat selection at the time the reservation was made, it is possible for he or she to do so at this time, as well as to obtain a boarding pass and various information.

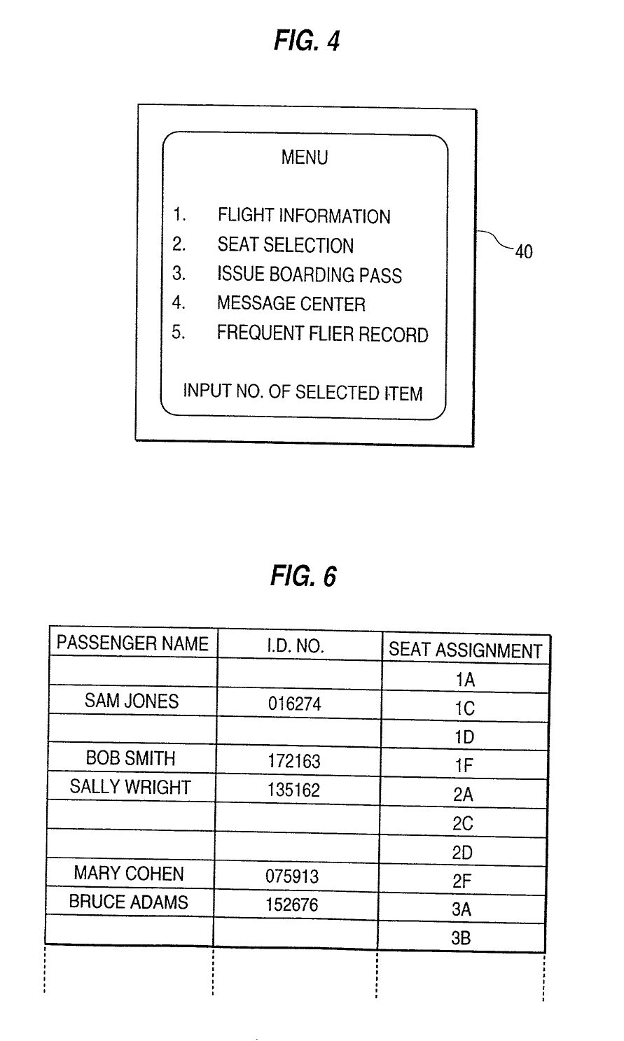

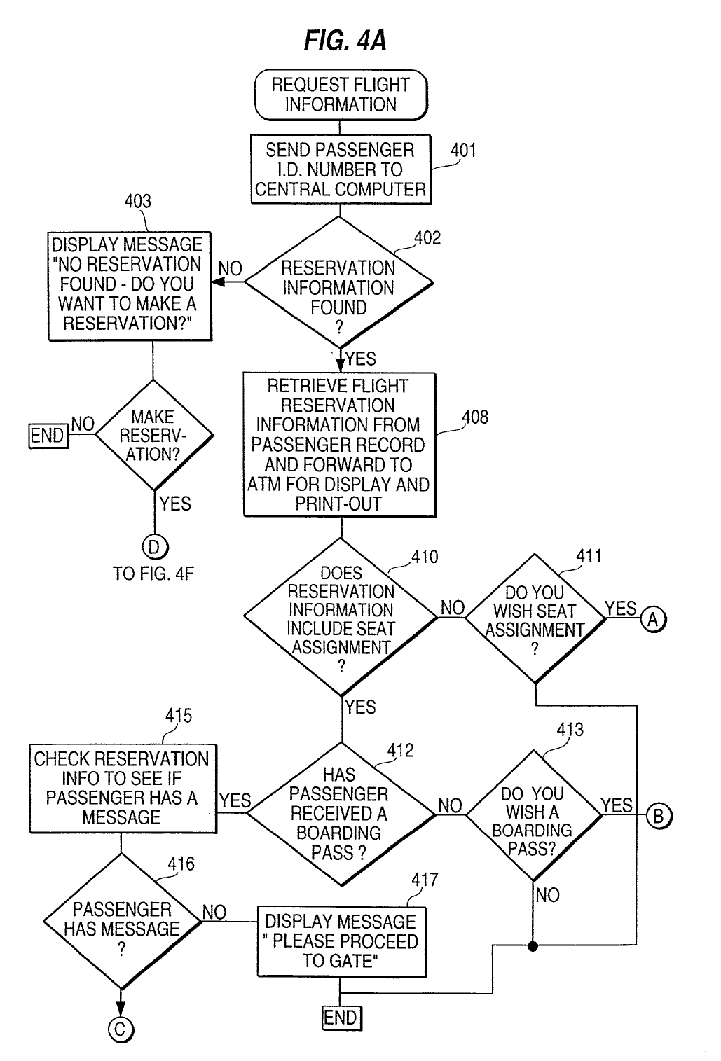

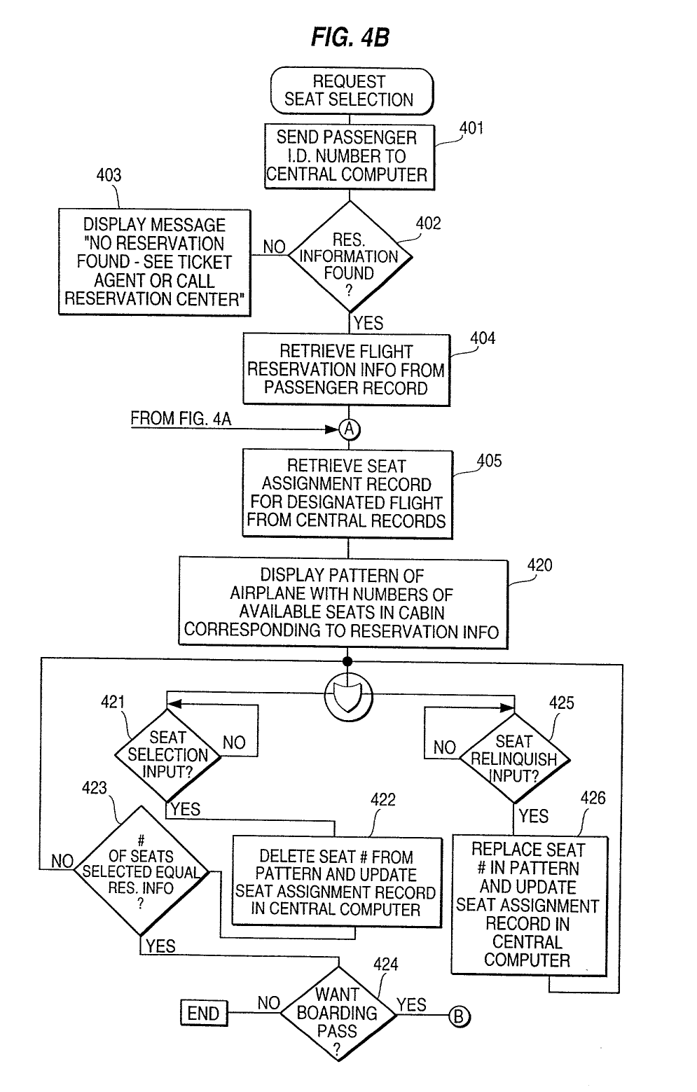

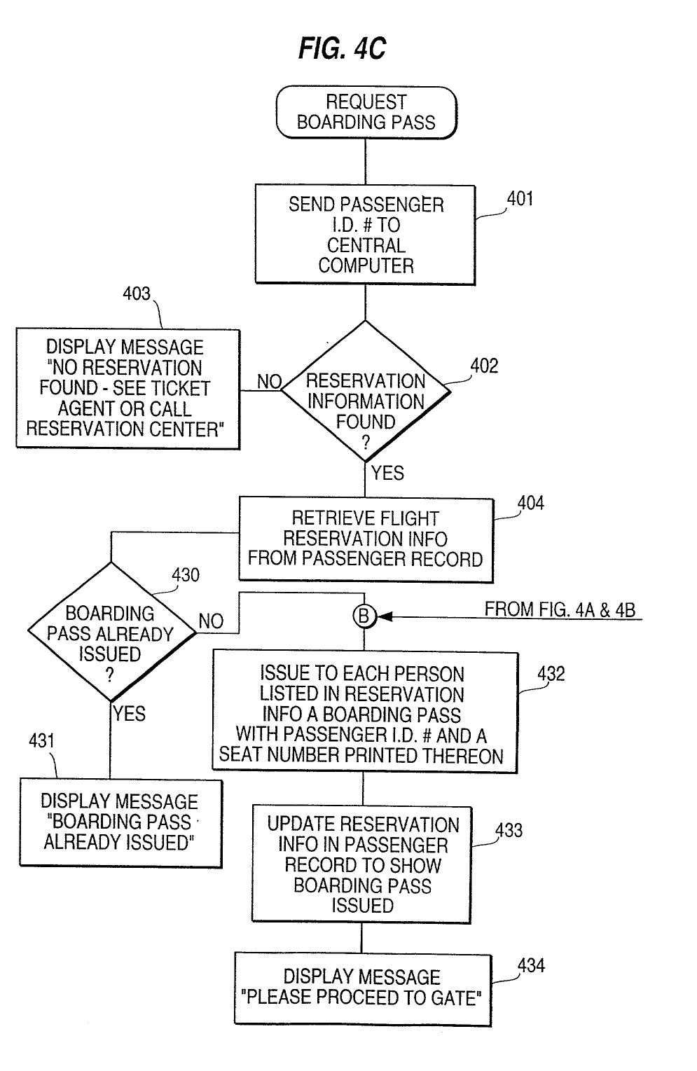

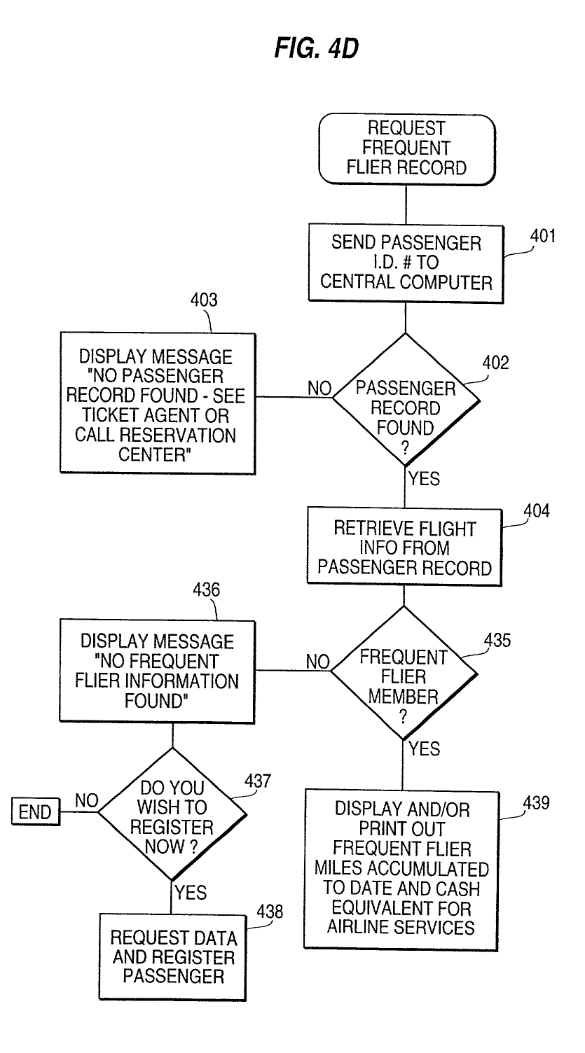

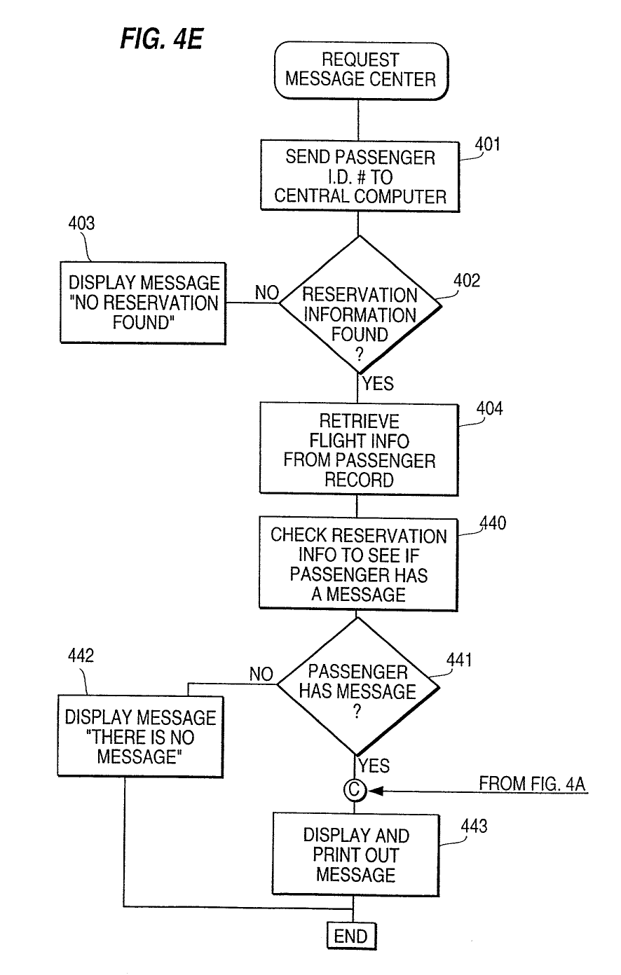

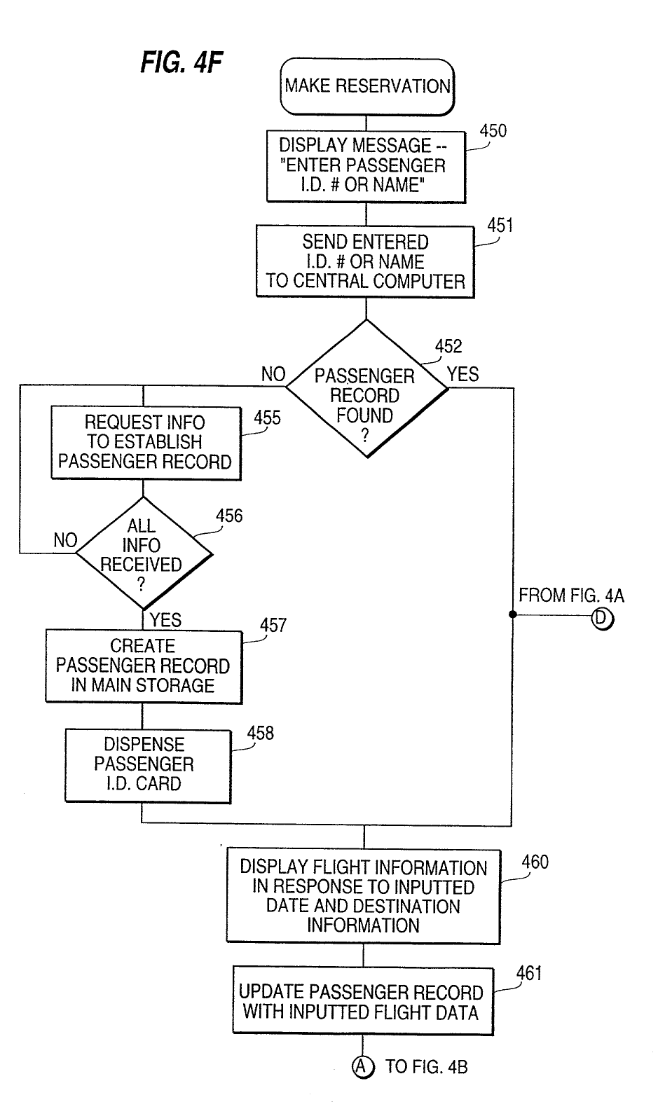

More particularly, when the passenger swipes his or her card through the reader of the ATM, the screen will provide a menu from which various items can be selected, including “flight information”, “seat selection”, “frequent flier record”, “issue boarding pass”, “message center” and “make reservation”, as seen in FIG. 4. Such selection may be made through a keyboard at the ATM or by use of a touch screen.

Typically the passenger will choose “flight information” from the menu, causing the flight information stored in the main computer to be displayed and/or printed out, as indicated by the process shown in FIG. 4A. In step 401, the passenger I.D. number read from the passenger's card (or the passenger's name entered through a keyboard) is sent to the central computer, which accesses the passenger records in main storage and searches for a record bearing the I.D. number or passenger name, in step 402. If no record is found under either of these identifiers, the process moves to step 403, in which the main computer causes the remote terminal to display the message NO RECORD FOUND. Similarly, if the passenger record is found, but there is no reservation information in the record, the main computer causes the remote terminal to display the message NO RESERVATION FOUND-DO YOU WANT TO MAKE A RESERVATION. If the individual responds with YES at step 406, the process moves to steps for making a reservation, which will be described later with reference to FIG. 4F.

If valid reservation information is found at step 402, the main computer will retrieve all reservation information fields relevant to the current date from the passenger record in main storage and forward this information to the remote terminal, at step 408. The remote terminal will display and printout relevant information, such as passenger name, flight number, departure time, gate number and seat assignments for all members of the party, if seats have been assigned.

The remote terminal will then determine from the received information whether a seat or seats have already been assigned to the passenger and those accompanying him or her, if any, for the indicated flight, at step 410. If there has been no seat assignment, the remote terminal displays a message DO YOU WISH TO MAKE A SEAT SELECTION? at step 411. If the passenger responds YES, the process shifts to that for seat assignment, which will be described later with reference to FIG. 4B. If the passenger responds NO at step 411, the process ends, since the passenger is not allowed to obtain a boarding pass until a seat or seats have been assigned for the flight.

If at step 410 it is determined that the passenger and all accompanying persons have received a seat assignment, it is determined in step 412 if the passenger and accompanying persons have received a boarding pass. If no boarding passes have been issued to this passenger for the flight in question, the remote terminal displays the message DO YOU WISH A BOARDING PASS? at step 413. If the passenger responds YES, the process shifts to that for issuing boarding passes, which will be described later with reference to FIG. 4C.

If it is found in step 412 that a boarding pass or passes have been issued to the passenger, the remote terminal will check the reservation information field to see if the passenger has a message, at step 415. If it is determined at step 416 that the passenger has a message, then the process shifts to that for display of messages, which will be described later with reference to FIG. 4D. If there is no message for the passenger at step 416, the remote terminal displays at STEP 417 the message PLEASE PROCEED TO GATE.

When the passenger arrives at the concourse of the airline terminal, he or she may not wish to access flight information if such information is already known, particularly where the passenger is in a hurry to catch his or her flight, but does need to obtain an assigned seat and/or a boarding pass. In this case, when the menu is displayed at the ATM following the reading of the passenger's I.D. card, the passenger may select “seat selection” and initiate the process shown in FIG. 4B. In this process, the steps 401 to 403 are the same steps as described with reference to FIG. 4A.

In step 404, the main computer will retrieve flight reservation information from the passenger record and forward this information to the remote terminal similar to step 408 in FIG. 4A, but in this case the flight reservation information will not be displayed. In step 405, the remote terminal will access the main computer to retrieve the seat assignment record for the flight designated in the passenger's flight reservation, and, in step 420, the remote terminal will display a pattern of the airplane in which there is shown the numbers of the available seats in the cabin corresponding to the reservation information, as shown in FIG. 6.

At this point the passenger may either select a seat or seats or relinquish a seat or seats already assigned to him or her. Instructions for both processes will be displayed to guide the passenger. If the passenger chooses to select seats, the remote terminal will detect a seat selection input at step 421. In response thereto, the number of each selected seat will be immediately deleted from the display, providing a visual verification of the seat selection to the passenger, and the passenger reservation information will be updated to reflect this seat selection. At step 423, a comparison is made between the number of seats selected and the number of members in the passengers party, as indicated in the reservation information. If the passenger has not selected all seats for his or her party, the process awaits another input. At this point the passenger may change his or her mind concerning a previous seat selection, in which case, a seat relinquish input will be detected at step 425. In response thereto, the number of the relinquished seat will be replaced in the pattern and the seat assignment record will be updated accordingly.

Each time there is a seat selection, the remote terminal will verify whether the selected seat is available in the seat assignment record in main storage before the seat selection is accepted, so as to prevent conflicting seat selections from two remote terminals at substantially the same time. If at step 423 it is determined that the passenger has selected all seats for the flight, the remote terminal will display the message DO YOU WISH A BOARDING PASS? at step 424. If the passenger responds with YES, the process shifts to that for issuing a boarding pass, which will be described with reference to FIG. 4C.

In FIG. 4C, the steps 401 to 404 are the same as in FIG. 4B. In this regard, a passenger who already knows the flight information and has an assigned seat may wish only to receive a boarding pass. This is initiated by selecting “boarding pass” from the menu which appears when the passenger's I.D. card is read. Verification of passenger identity is inferred from the fact that the passenger has an I.D. card. In the alternative, the use of fingerprint identifying data or retina scan identifying data in the manner already described with reference to baggage check-in using a scanner at the ATM. If the passenger does not have an I.D. card, because the card has been lost or stolen, then the passenger would have to obtain a boarding pass at the gate where the passenger's identification can be checked by an airline agent. If a third party obtains a boarding pass using the passenger's card and the passenger attempts to obtain a boarding pass at the gate, the conflict will become immediately apparent at step 430, when the reservation information indicates that a boarding pass has been issued and this information is displayed at step 431. The matter can then be resolved by checking the passenger's identification and checking to see who attempts to occupy the seat assigned to the passenger.

At step 432, having verified that the passenger has not received a boarding pass, a boarding pass or passes bearing the I.D. number of the passenger and a respective seat assignment will be issued. At step 433, the reservation information in the main record will be updated to indicate that boarding passes have been issued to the passenger, and, at step 434, the remote terminal will display the message PLEASE PROCEED TO GATE. Actually, this same process for obtaining a boarding pass can be carried out at curbside baggage check-in, at the airline counter or at the gate, since the remote terminal at each of these locations will have the similar ability to print this receipt.

The boarding pass is only a receipt for the verification of the flight reservation and is not an airline ticket. However, it also may be used to evidence the boarding of the passenger on the plane. For this purpose, the passenger may be required to insert a boarding pass having his I.D. number on it into an optical or magnetic reader as he enters the boarding ramp to the plane. The optical or magnetic reader reads the passenger I.D. number from the boarding pass and transfers this information to the main computer where an indication of boarding is stored in the passenger's record. The main computer can then compare baggage check information with this boarding information and determine from its records whether anyone has checked a bag, but has not boarded the plane before the plane departs, indicating a possible security problem, not to mention the possibility that a late arriving passenger, who has checked in at curb-side baggage handling, a remote location ATM or a baggage ATM, is still making his or her way through the terminal to the gate for that flight, which information can be communicated to the gate from the main computer so that the flight can be held.

Going back to the menu displayed at the ATM, the passenger may select “frequent flier record” to obtain information as to the current frequent flier miles he or she has accumulated, and possibly also the frequent flier miles to be awarded for any flights indicated in the reservation information stored in his passenger record in main storage. Thus, the passenger will be able to determine how many frequent flier miles will be available for use in buying services on the flight, as will be described in more detail later. Referring to FIG. 4D, the steps 401 to 404 are the same as the corresponding steps in FIGS. 4B and 4C. At step 435, the remote terminal will determine from the passenger record whether the passenger is a member of the airline frequent flier program. If NO, the remote terminal will display the message NO FREQUENT FLIER INFORMATION FOUND. The remote terminal will at step 437 request whether the passenger wishes to register now, and if the passenger responds YES, at step 438, the data required for registration is requested and the passenger is registered by updating his or her passenger profile information in the passenger record in main memory. The passenger may then get credit for the current flight.

At step 435, if it is found that the passenger is already a member of the frequent flier program, the remote terminal will display and/or print out the frequent flier miles that the passenger has accumulated to date and the cash equivalent thereof for use in purchasing airline goods and services, as will be explained later. Incidentally, when a boarding pass is submitted and read into the system, or a passenger I.D. card is read at the gate, upon boarding, the system will automatically update the frequent flier record of the passenger. Thus, the record of frequent flier miles for each passenger will always be current.

If the passenger selects “message center” in the menu displayed at the ATM, any messages left for the passenger will be displayed on the screen. Thus, upon arrival or departure at any airport, passengers can check for messages left by third parties. For this purpose, a special telephone number is allocated by the airline to enable third parties to access a computerized message center, or the third party can call the reservation center, to have a message or instructions stored in a field under the passenger identification in the records of the main computer. In addition, the airline could maintain a special internet address for receiving messages for its passengers. Upon receipt of an e-mail message sent to this address for a specified passenger, the main computer will access the passenger records using the passenger name and store the message in the message field of the passenger record. This feature could also be used by the airline and its employees for internal company use.

Referring to FIG. 4E, steps 401 to 404 are the same as the corresponding steps as described previously. In step 440, the remote terminal checks the received passenger reservation information to see if the passenger has a message. If it is determined in step 441 that the passenger has no message, a message THERE IS NO MESSAGE is displayed at step 442. If there is a message for the passenger, the message is displayed at step 443.

While the message center can be accessed at each ATM on the terminal concourse, a remote terminal which serves only as an access to the message center may be provided at the gates to allow passengers on connecting flights to access their messages en route. Such a dedicated message center may also be provided on the concourse to reduce congestion at the ATMs caused by passengers who only wish to check for messages. In addition, within the dedicated message center or in the vicinity thereof, there could be provided telephones of the type that will read credit cards to pay for long distance calls. These telephones could also be programed to read a passenger I.D. card to access a passenger record and charge a long distance call against the passenger's frequent flier miles, as will be discussed in more detail later. In this way, a passenger may check for messages at the ATM or dedicated message center, check his frequent flier record to determine the extent of accumulated miles therein (and the cash or trade equivalent, as will be discussed later), and place toll calls using his or her personal I.D. card.

The ATM is also available to those who need to make reservations. Referring to FIG. 4F, when an individual enters his or her I.D. number or name at the ATM at step 450, this information will be forwarded to the central computer in step 451 to access a passenger record. If no passenger record is found at step 452, the individual will be led at step 455 by a series of screens to enter information necessary to establish a passenger record and a passenger I.D. number will be assigned in a manner similar to that described with reference to step 10 in FIG. 1A. The ATM will then dispense a plastic I.D. card having the I.D. number recorded thereon to the individual at step 458.

If the passenger's record is found at step 452, or after the passenger is issued a card at step 458, the ATM will request information as to a desired date of departure, destination and point of embarkation, and display information for all flights relating to these requirements at step 460. The individual may then select a flight, or flights in the case of connecting flights, and the passenger record will then be updated at step 461 to indicate the reservation after payment by credit card account has been verified. The process will then proceed to seat selection in FIG. 4B.

Returning to FIG. 1B, once the passenger has received directions from the ATM at block 12, the passenger proceeds to the departure gate area. One of the features of the invention resides in the fact that, if the airline wishes to avoid the need for boarding passes, the passenger I.D. can be used in the manner of a boarding pass. At the departure gate a mobile airline communications system 15 may be employed by the airline. Typically, airline personnel, such as agents or stewards and stewardesses, can man the mobile airline communications system, which is comprised of a cellular telephone connected to a lap top computer and includes a magnetic card reader. The passenger hands his or her I.D. card to the airline personnel who swipes the card through the card reader of the lap top or portable computer, and the cellular telephone network instantly communicates with the main computer and verifies and validates the fact that the passenger has a reservation on that particular flight and that the payment has been made for the flight. This could also be accomplished without the use of a personal identification card by transmitting fingerprint or retina scan information to the main computer to verify the reservation. This is an individual personal validation at the departure gate which then allows the passenger to enter the plane. For this purpose, the mobile airline communication system communicates by cellular telephone with the main computer memory via the central computer to provide proper validation.

Thus, the passenger reservation is validated at block 16. The agent may then simply motion for the passenger to board the airplane, or there may be provided a green “pass” light to indicate that the passenger should proceed to the plane or a red “don't pass” light to stop the passenger and alert the agent. Thus, the passenger enters the airplane at block 19. At this time, the reservation number for that flight may be removed from the main computer records, since the passenger has entered the airplane.

At block 13, if the passenger loses his or her card, then another card can be mailed with the same I.D. number, as seen at block 14. However, even if the passenger should lose his or her card prior to arriving at the airport, the passenger can still be validated just by providing the passenger's name and/or the I.D. card number and proper identification. The card I.D. number is the access number that gets into the main computer records that provides for all reservation and validation information; however, access also can be obtained using the passenger's name. Obviously, if the passenger loses the I.D. card, then the passenger must provide personal identification, such as a driver's license or the like. Again, this would be obviated if the main computer records included a current photo of the passenger, or fingerprint or retina scan identification data.

Going back to the terminal in the airport and the ATM 12, should the passenger miss the flight or decide to change the flight, this can be accomplished by calling the reservation center and making flight reservations providing for a revised reservation number that includes the new flight number and payment authorization. For this purpose, the ATM may include a telephone for communicating with the reservation center, or the making of new reservations may be provided by way of menu item 6, as described with reference to FIG. 4F, which, upon selection will allow the passenger to change his or her reservations without the need to see a ticket agent. As already indicated, this can be carried out using the ATM much in the same manner that items are now purchased over the internet.

The use of the present system eliminates all paper ticketing at each step of the way, whether it is arriving at the airport or arriving at the departure gate, where the person can, using the plastic I.D. card, have it read at the card reader and ensure validation with the airline personnel at the boarding gate. This can be done even without the I.D. card, but of course it will slow things down if the passenger has to provide name and identification at the boarding gate.

Once the passenger has boarded the airplane, other services may be made available to him or her using the personal I.D. card. For example, many airplanes today are equipped with telephones mounted in a seat back in front of the passenger, as well as video screens at each seat for the use of the passenger. Associated with the telephone is a card reader, which will allow a passenger to charge a telephone call to his or her credit card account. However, in accordance with the present invention, the card reader also can be used to read the passenger's I.D. card to access the main storage of the central computer, where a record of the passenger's accumulated frequent flier miles is stored. The airline will then allow the passenger to use frequent flier miles like cash, in a predetermined ratio of miles to cash, to pay for a telephone call from the airplane. At the time the passenger accesses the central computer using his or her personal I.D. card, the system determines from the passenger record in main memory the cash or trade equivalent of frequent flier miles available and displays this amount, or the equivalent calling minutes available, to the passenger. If the passenger proceeds with the telephone call, when the call is completed, the cost of the call is automatically debited from the frequent flier miles in the passenger's account, with the system performing the conversion of frequent flier miles to cash or a trade equivalent.

Frequent flier miles could also be used for other activities and services much like the telephone services mentioned above. For example, the passenger could pay for refreshments which normally require a cash payment. For this purpose, the flight attendant would use the mobile communication system previously employed at the gate, or a similar portable computer with wireless capability, to read the passenger's I.D. card and access the central computer to debit the passenger's frequent flier account by an amount required by the purchase, again with the system performing the conversion of frequent flier miles to cash or trade equivalent. This could eliminate the need for the flight attendant to handle cash, which is often a problem, especially with respect to providing correct change for large bills, and solves a problem for a passenger who may be short of cash, such as someone on a return flight from Las Vegas. For some preferred passengers who do not have enough accumulated frequent flier miles for a particular purchase, the airline could allow the purchase to be debited against future miles, or charge the difference to the passenger's credit card account.

Many people, although members of a frequent flier program, do not fly enough to earn enough miles to warrant free travel, and others travel so extensively that they will never be able to take advantage of the number of free flights they can earn. For such people, the ability to use frequent flier miles to make telephone calls (especially the very frequent flier businessman) and pay for refreshments would be particularly attractive. In the same way, frequent flier miles can be offered by the airline in payment for other activities on the airplane, such as access to movies, video conferencing, video gambling and language courses via the video screen provided at each passenger seat. Of course the telephone facility also allows internet access for those passengers who have an internet provider, or the airline could provide free internet access (possibly made available as a promotion by a large internet provider) to allow passengers who have not used the internet to experience such use.

The system can be employed not only for common carriers such as airline or other similar type reservations, but can be used for hotel reservations with prepayment established for fixed check-in and check-out times with the check-in at the hotel being with an ATM automatic teller machine, such as at a kiosk in the hotel lobby, that provides the room number, where a card could also be used to activate the room door by-passing the desk completely for check-in and checkout purposes. This would also include credit card authorization in a network where expenses incurred at the hotel will be automatically charged to the credit card account, such as mini-bar usage and pay-TV programs. The personal I.D. card could be used not only to record the purchase of goods and services, but also to produce a record of the activities to provide frequent user incentives for the use of certain services similar to the incentive programs provided by airlines to allow patrons a debit system of accumulated credit for hotel services, such as TV, mini-bar, telephone calls, car rentals, gas and cellular phone credits. Check-out of the hotel could be accomplished by merely inserting the card in the card reader and noting the time and date that the hotel participant left.

One of the key elements in the system is the mobile or land airline communication system which allows for card reader computer activation through a cellular or land telephone network with the main computer to provide mobile pre-site locations for identifying and authorizing the reservation and the fact that it was prepaid and that the person is therefore validated. Such mobile sites can be set-up anywhere, whether it be in an airport, a train station, hotels or at car rental places.

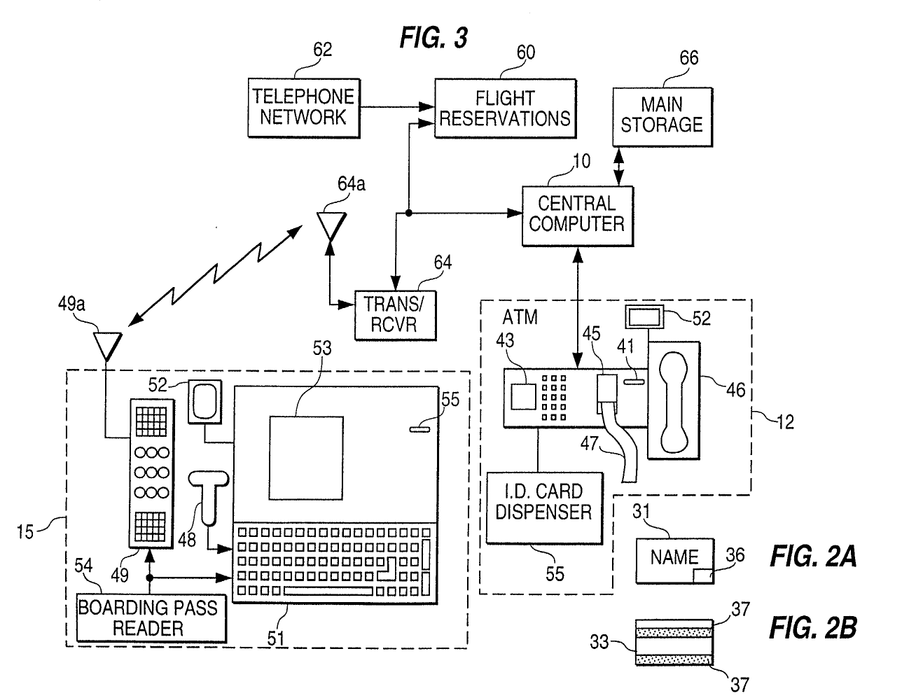

Referring now to FIG. 2A and FIG. 2B, the typical plastic I.D. card is shown, which is of a conventional type and typically contains on a magnetic bar strip 37 the particular I.D. number of the card itself, but does not include any reservation authorization or flight information per se. The card may also include two magnetic bar strips 37, one for accessing the main airline computer and the other providing information for credit card payments, so that the card not only operates as an airline or other type of identity card, but also as a typical credit card. The front 31 of the card in FIG. 2A is shown as displaying the name of the passenger, while the back 33 of the card shows in FIG. 2B magnetic strips 37, but may also include a statement of the appropriate federal regulations required of all Warsaw Pact countries. As seen in FIG. 2A, the card may also contain a chip 36 or other type of storage device capable of storing graphic data in digital form, such as fingerprint or retina scan identifying data for card holder verification, as already described. The card is useful for expediting entrance and egress in various particular environments for instant authorization and validation of the particular person carrying the card by permitting use of the card at an automatic teller machine for providing information, as previously described, and for providing an I.D. for boarding an aircraft or accessing a hotel room or renting a car by merely inserting the I.D. card in a card reader for verification and validation of the person who has the card.

Referring now to FIG. 3, the invention is implemented by a central computer 10, such as a main frame computer, connected to a main storage 66 that holds each passenger record, providing all the basic flight and passenger profile information, as seen in FIG. 6, including the name of the passenger, the telephone number of the passenger, the reservation number assigned to the passenger once payment has been made and the identification card number of the passenger, along with information concerning authorization and payment validation and access to the passenger's credit card company records.

The central computer 10 is connected to a flight reservations center 60 that allows flight reservations personnel to input data to and access the central computer at all times. A conventional telephone network 62 allows for call-in on a 800 number or direct phone line to personnel at the flight reservations center 60 for making a reservation on a particular flight. The central computer 10 also may be accessed through a transmitter and receiver system 64, that will be explained in greater detail below, and the central computer 10 also may be connected to an automatic teller machine 12 located at the airport terminal. The system also utilizes a mobile airline communication device 15 which includes a cellular telephone 49 having an antenna 49A and a lap top computer 51 that includes a visual display 53 and a magnetic card reader 55. Of course, the communication device 15 may also take the form of a relatively fixed location remote terminal, as well, and is provided for use by airline agents for passenger check-in and boarding. Thus, the communication device 15 may be provided at curb-side baggage check-in, at a ticket counter and at the flight boarding gate. The communication device 15 provided at the boarding gate may also include or be associated with a boarding pass reader 54, which reads a passenger I.D. number from a boarding pass and sends this information to the central computer.

The system of FIG. 3 is operated as follows. A passenger or travel agency typically utilizes the conventional telephone network 62 and calls the airline flight information and reservation service center 60. A flight reservation is then determined in central computer 10 to be available, and, if available, a passenger name, address, and phone number is entered into main storage 66, while credit card information obtained from the prospective passenger or main storage 66 is sent to the passenger's credit card company by the central computer for payment authorization and verification. If a passenger has an I.D. card already, then the I.D. number will be used to pull up the passenger's record in main storage 66. If the passenger does not have an I.D. card, then an I.D. card number is assigned when the reservation number is assigned. If sufficient funds are available, then the central computer transfers funds to the airline through the credit card records.

At this point a reservation number is created in the central computer and validated for a particular passenger and the passenger I.D. card number. A reservation operations center would then mail out an I.D. card with the I.D. number to the passenger. If the passenger already has a pre-issued I.D. card, then only the itinerary is mailed, faxed or, if elected, picked up at the airport or a special ATM. The passenger would then go to the airport terminal on the day of the flight and either check bags at curb-side, or, upon walking into the terminal, will see a kiosk containing one or more automatic teller machines 12. As already indicated, check-in can be completed when bags are checked; however, if the passenger has no bags to check, he or she may proceed directly into the terminal for check-in.

The automatic teller machine 12 in the airline terminal includes a card reader slot 41 which is attached to a magnetic card reader connected to the automatic teller machine. A CRT or other visual display 43 (possibly with a touch screen) is provided at the automatic teller machine, along with a printer 45 that includes a printout tape 47 to provide the same information on the tape as that provided on the display screen 43. There is also a scanner 52 to detect a fingerprint or to scan the retina of the passenger who is checking in, thereby verifying the identity of the card holder with reference to identifying information stored the main storage 66. If the passenger identity is not verified, the system will not provide information from main storage 66 to the card holder. If the passenger does not have a previously issued I.D. card, the passenger will be asked to provide information necessary to establish a passenger record in main storage, as described with reference to FIG. 4F, and the card dispenser 56 will then issue an I.D. card to the passenger.

Once the passenger puts the card in the card reader 41, the visual display will present a menu of items, as already described, and the passenger will typically select “flight information” from the menu, causing the display screen to show information, such as departure gate, time of flight, flight number and other relevant information, including directions as to how the passenger can get to the gate, as already discussed. This information also may be printed out on the tape 47. If the passenger wishes to change his or her reservations, a telephone 46 is provided at the ATM to allow the passenger to communicate with the reservation center. In the alternative, using a touch screen or the keyboard, the passenger may make a reservation change (or an additional reservation) without the direct assistance of the reservation center, as already described with reference to FIG. 4F. The passenger would then obtain a boarding pass in the manner already described and then proceed to the departure gate.

At the departure gate, the airline may provide an optical or magnetic reader 54 for those passengers having a boarding pass, the optical or magnetic reader being connected by direct telephone line or by wireless communication to the central computer 10. Upon boarding, the passenger will insert the boarding pass into the optical or magnetic reader, which will then read the passenger I.D. from the boarding pass and communicate this information to the central computer 10. Instead of an optical or magnetic reader, the communications system 15 may also have a portable bar code scanner 48, which allows the airline agent to scan a bar code on the boarding pass, which indicates the passenger I.D. number, as the passenger enters the boarding ramp. The computer then stores in main memory 66 an indication that the passenger has boarded the aircraft.

The mobile airline communications system 15 also may be employed at the departure gate by one or more employees of the airline, such as agents, or the stewards and stewardesses who will also be departing on the flight, to process those passengers who do not have an issued boarding pass, but wish to use their I.D. card as a boarding pass. This may apply to a person who is running late and must proceed directly to the gate, bypassing the ATM. The airline person at the gate can use a lap top computer 51 that has also a magnetic card reader slot 55 and a magnetic card reader device electrically connected therein and a visual display screen 53 to provide verification and validation information to the airline employee. The lap top computer includes a cellular telephone 49 having an antenna 49A connected electrically thereto which allows for transmission of information from the lap top computer back to the central computer 60 through the transmitter receiver 64 for instant validation of the particular passenger once the plastic identification card is inserted into the magnetic card reader slot 55, as well as to facilitate other services on board the aircraft. Again, a scanner 52 may be provided to verify the identity of the card holder in the manner already described.

The mobile airline communications system 15 is portable and can be carried on and off the flight by the airline personnel. Thus, the passenger to board the aircraft need only hand his or her I.D. card to the airline personnel, who places it in the lap top computer and looks at the screen to receive an authorization or validation that the person has paid for the particular flight and that this is the proper flight. Using the mobile airline communications system 15, mobile sites can be selected anywhere and still allow access to the central computer, whether it is at different boarding gates, if changes have to be made, and which can be carried with the airline personnel alleviating the necessity for a small airline to employ an excessive number of permanent gate operating employees. The flight personnel can also use the mobile airline communications system at all subsequent stops on the route, as well as on board the flight, for various services, as will be described in more detail later.

Should the passenger lose the I.D. card or not have the I.D. card available at the boarding gate, then the airline personnel can enter information manually into the lap top computer 51 indicating the person's name and still obtain a validation and authorization on the visual screen. At this point the passenger would have to produce personal identification before the person could be allowed on board the aircraft, unless the system provides an identifying photo, fingerprint data or retina scan data of the passenger in main storage 66. Thus, the present system allows for a particular individual to be personally validated at various check points along with a preplanned activity without the necessity of using paper ticketing for check-in and boarding purposes.

While the foregoing description makes reference to the provision of one or more ATMs in the airline terminal, it should be understood that ATMs could also be provided at other convenient locations where passengers may access their passenger records and make reservations and change reservations. For example an ATM could be provided in a hotel or business office lobby for the convenience of the traveler and business passenger.

The overall system could also be employed for hotel reservations wherein the reservations are made and the payment is made. Once the party checks into the hotel with the plastic I.D. card at a mobile check-in station, the person could proceed to the room designated where the card could also be used to access the room for certain periods of time that are authorized by the central computer. Check-in and check-out could be eliminated. Additional information could be provided in an automatic teller machine provided in the hotel or in the mobile communications system, as desired.

Finally, the system could be used in other environments, such as requiring prepaid, planned activities, such as renting an automobile. Again, the I.D. card would be used to access a mobile station at the check-out car center, which provides authorization and automatically identifies the car to be rented and its location after authorization to allow the party to use the car. This information is printed out along with the rental contract, which then may be used as a pass to take the car out of the car rental center.

The use of the I.D. card allows for expeditious handling and transfer and validation at each point along the way. The card I.D. number, which is coded on the card and which identifies the card holder, provides the particular access to the central computer containing information on schedules, prepayment, and flight information.

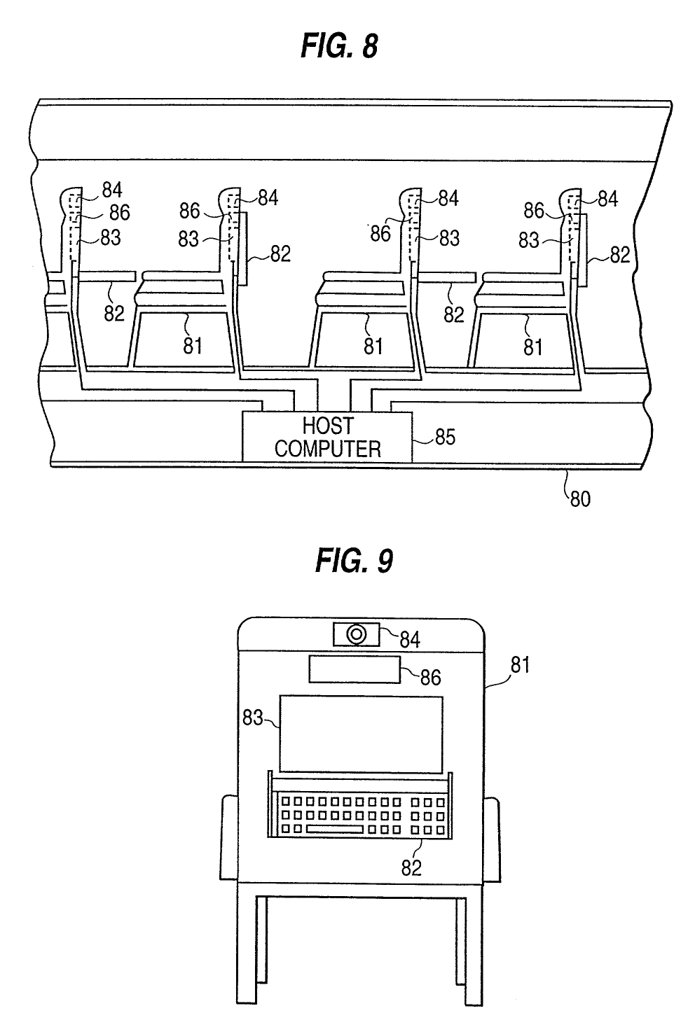

On board the aircraft, various other features and services may be made available to the passengers according to the present invention. For example, as seen in FIGS. 8 and 9, in addition to the telephone 86 and viewing screen 83 presently provided on airplanes today for use by passengers, connections for a computer terminal 82 could be provided at each seat, so that a computer terminal (rented to the passenger by the airline for a specified cost) could be provided at each passenger seat 81 for use by the passenger during the flight. This could be a dumb terminal networked with a central computer 85 on the airplane, or an independent smart terminal. Thus, the business passenger would only need to carry on to the flight those computer disks needed for the work they wish to do during the flight. The cost of rental of this equipment could be charged to the passenger's credit card or against the passenger's frequent flier miles using the passenger's I.D. card, as already described. For this purpose, and to facilitate other charges by the passenger, the computer 82 would have a card reader (not shown), or the card reader typically associated with the telephone 84 could be linked with the computer 82.

The present invention also contemplates the provision of intra-plane communication, i.e. communication within the airplane cabin between passengers, using the telephones 86 provided at each seat. Thus, members of the same family, or traveling business companions, who are separated within the cabin could communicate with one another during the flight, which would be particularly advantageous when the passengers are not able to move freely about the cabin, such as at the time of take-off and landing and when the fasten seat belt sign is on. This could be implemented in the same manner as a typical PBX system, with the seat number serving as the called party number. Again, a charge may be applied to such calls by the airline, which charge could be applied against the passenger's frequent flier miles, or such calls could be offered free as a service to it's passengers or only to first class passengers, for example.

Intra-plane communication could be extended beyond telephone calls to data communication between seats in conjunction with the display screens provided at each seat. In this regard, such data communication could allow a passenger to play a game with another passenger or group of passengers located elsewhere in the cabin, such as poker, bridge, chess, checkers, backgammon and various board games. The airline may also run bingo in the cabin, which a passenger can participate in by paying a certain fee for each game (charged against his or her frequent flier account or credit card account using the passenger I.D. card), with the airline giving prizes to the winners.

The provision of telephone communication between seats could also be supplemented by providing video cameras 84 at each seat to allow passengers at different locations in the airplane to see each other. This would effectively provide a video conferencing capability, but also would allow parents to monitor the activities of their children who are not seated near them. By using a split screen video display, more than one person could be seen at one time, thereby facilitating the monitoring of two or more children. Certainly, a passenger's privacy needs to be protected, and so a passenger will not be allowed to view another passenger without their knowledge or consent. Thus, to view another passenger, it would be necessary to contact that passenger by telephone and have that passenger initiate the connection which will allow the viewer to see that passenger on the screen. In the case of children being viewed by parents, the parent will ask the flight attendant to initiate the connection from the children's seats. These services could require payment to the airline, which payment could be made using the passenger's I.D. card to access frequent flier miles or a credit card account.

The passenger's I.D. card may have other uses during a flight. For example, an airline will sometime offer a duty free shop on board flights returning from other countries. In such a case, the airline may allow a passenger to purchase duty free goods using frequent flier miles using the I.D. card. The airline could also provide a shoppers channel as a selection on it's video programming and allow passengers to purchase goods (to be shipped to their homes) using frequent flier miles. In this regard, by using the passenger I.D. card for the purchase, the shoppers channel is able to access the personal profile information in the passenger's record and not only access the frequent flier record and credit card information relevant to the passenger, but also the passenger's home address, so that a purchase by the passenger can be performed quite simply.

Various amenities that might make the passenger's flight more pleasurable or provide information needed at the passenger's destination might also be offered to the passenger for a specified charge which could be paid for using the passenger I.D. card. For example, the computer system on the airplane could have a data base which stores a wide selection of magazines, books and movies, for example, that the passenger may select for viewing at his or her seat, using frequent flier miles. The computer data base could also store map data representing the destination city or town, as well as lists of hotels, restaurants, various points of interest and their locations, which the passenger may access on his or her video screen for a specified charge using frequent flier miles. By providing a printer at each seat or group of seats, a print-out of any information provided on a passenger's video screen could be obtained for the passenger's future use, again at a specified charge.

With respect to the frequent flier miles which a passenger may use to purchase goods and services, it is to be noted that such miles may be accumulated not only in connection with flights taken by the passenger, but may be obtained as well as part of a program offered by credit card companies, wherein a card holder receives a specified amount of frequent flier miles for use of the credit card to make purchases.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method of validating a reservation for an airline flight, in order to eliminate the need for paper tickets, said method comprising the steps of:
making a reservation for a particular airline flight for a particular individual without issuing a paper ticket to the individual;
storing reservation data, which identifies the individual and the particular airline flight for which the reservation has been made, in a reservation data storage area of a central data bank;
transmitting personal identification information, which is obtained from the individual at a selected location in an airline terminal, to verify the reservation for the particular airline flight, by accessing the reservation data stored in the central data bank, and effect automatic validation at the selected location to permit the individual to board the flight without requiring a paper ticket, whereby access to airline flights can be effected without the need for issuing a paper ticket to the participating individual;
storing information in the central data bank indicating that the individual has checked baggage to be carried by the particular airline flight when the individual checks baggage at the airline terminal prior to boarding the airline flight;
storing information in the central data bank for each individual who boards the particular airline flight indicating that the individual has boarded; and
comparing the information in the central data bank which identifies individuals who have checked baggage for the particular airline flight with information in the central data bank which identifies individuals that have boarded the particular airline flight to determine whether any individual who has checked baggage has not boarded, before the particular airline flight departs.

2. A method of validating a reservation as defined in claim 1, further comprising the steps of:
creating in the central data bank an airline flight record which identifies all individuals holding reservations for a particular airline flight, said airline flight record further including an indication whether an individual listed for the particular airline flight has checked baggage for the flight and an indication whether said individual has boarded the flight; and
updating said airline flight record when said central data bank receives information that an individual has checked baggage and when that individual has boarded the airline flight.

3. A method of validating a reservation as defined in claim 1, further comprising the step of:
creating in the central data bank a passenger record for an individual who makes a reservation for an airline flight, said passenger record including reservation fields each relating to a respective flight for which said individual has made a flight reservation, each reservation field including information indicating a flight number, a flight departure date, a flight departure time, and a gate number for the flight.

4. A method of validating a reservation as defined in claim 3, wherein said passenger record further includes individual profile information, including the name of the individual and special needs of the individual.

5. A method of validating a reservation as defined in claim 4, wherein said special needs include the need for special assistance in boarding.

6. A method of validating a reservation as defined in claim 4, wherein said special needs include special diet requirements.

7. A method of validating a reservation as defined in claim 1, further comprising the step of:
creating in the central data bank a passenger record for an individual who makes a reservation for an airline flight, said passenger record including at least the name of the individual and graphic data identifying the individual.

8. A method of validating a reservation as defined in claim 7, wherein said graphic data represents a photo of said individual.

9. A method of validating a reservation as defined in claim 7, wherein said graphic data is fingerprint identifying data of said individual.

10. A method of validating a reservation as defined in claim 7, wherein said graphic data is retina scan identifying data of said individual.

11. A method of validating a reservation as defined in claim 1, further including the step of creating in the central data bank a passenger record for an individual who makes a reservation for an airline flight, and wherein said step of storing information in said central data bank indicating that the individual has checked baggage includes storing in the passenger record of the individual claim check numbers of baggage tags attached to baggage which is checked by the individual.

12. A method of validating a reservation as defined in claim 11, wherein said claim check numbers are read from bar codes on the baggage tags using a bar code reader and transmitted from said airline terminal to said central data bank.

13. A method of validating a reservation for an airline flight, in order to eliminate the need for paper tickets, said method comprising the steps of:
making a reservation for a particular airline flight for a particular individual without issuing a paper ticket to the individual;
storing reservation data, which identifies the individual and the particular airline flight for which the reservation has been made, in a reservation data storage area of a central data bank;
creating in the central data bank a passenger record for an individual who makes a reservation for an airline flight, said passenger record including reservation fields each relating to a respective flight for which said individual has made a flight reservation, each reservation field including information indicating a flight number, a flight departure date, a flight departure time, and a gate number for the flight; and
transmitting personal identification information, which is obtained from the individual at a selected location in an airline terminal, to verify the reservation for the particular airline flight, by accessing the reservation data stored in the central data bank, and effect automatic validation at the selected location to permit the individual to board the flight without requiring a paper ticket, whereby access to airline flights can be effected without the need for issuing a paper ticket to the participating individual;
wherein said passenger record further includes individual profile information, including the name of the individual and special needs of the individual.

14. A method of validating a reservation as defined in claim 13, wherein said special needs include the need for special assistance in boarding.

15. A method of validating a reservation as defined in claim 13, wherein said special needs include special diet requirements.

16. A method of validating a reservation for an airline flight, in order to eliminate the need for paper tickets, said method comprising the steps of:
making a reservation for a particular airline flight for a particular individual without issuing a paper ticket to the individual;
storing reservation data, which identifies the individual and the particular airline flight for which the reservation has been made, in a reservation data storage area of a central data bank;
creating in the central data bank a passenger record for an individual who makes a reservation for an airline flight, said passenger record including at least the name of the individual and graphic data identifying the individual; and
transmitting personal identification information, which is obtained from the individual at a selected location in an airline terminal, to verify the reservation for the particular airline flight, by accessing the reservation data stored in the central data bank, and effect automatic validation at the selected location to permit the individual to board the flight without requiring a paper ticket, whereby access to airline flights can be effected without the need for issuing a paper ticket to the participating individual.

17. A method of validating a reservation as defined in claim 16, wherein said graphic data represents a photo of said individual.

18. A method of validating a reservation as defined in claim 16, wherein said graphic data is fingerprint identifying data of said individual.

19. A method of validating a reservation as defined in claim 16, wherein said graphic data is retina scan identifying data of said individual.

20. A method for validating a reservation for an airline flight, in order to eliminate the need for paper tickets, said method comprising the steps of:
making a reservation for a particular airline flight for a particular individual who has a reusable personal identification card having stored thereon identification information corresponding to the individual but no specific reservation or airline flight information;
storing reservation data, which identifies the individual and the particular airline flight for which the reservation has been made, in a reservation data storage area of a central data bank, including creating in the central data bank a passenger record for an individual who makes a reservation for an airline flight, said passenger record including reservation fields each relating to a respective flight for which said individual has made a flight reservation, each reservation field including information indicating a flight number, a flight departure date, a flight departure time, and a gate number for the flight;
reading the personal identification card of the individual at a selected location in an airline terminal to verify the reservation for the particular airline flight, by accessing the reservation data in the passenger record of the individual stored in the central data bank, and effect automatic validation at the selected location to permit the individual to board the airline flight without requiring a paper ticket; and
issuing a boarding pass to the individual to allow the individual to board the airline flight without presenting an airline ticket after the personal identification card is read and the reservation has been verified.

21. A method of validating a reservation as defined in claim 20, wherein said personal identification card is read at said airline terminal by a remote computer terminal, which displays reservation information accessed from a reservation field in said passenger record when said passenger identification card is read.

22. A method of validating a reservation as defined in claim 21, wherein each reservation field in a passenger record further includes seat assignment information.

23. A method of validating a reservation as defined in claim 21, further including the steps of:
creating in said central data bank a flight seat assignment record which lists each passenger for which a reservation has been made for a particular flight, the numbers of the seats on the flight and an indication of each seat assigned to a passenger;
responding to passenger identification information read from a passenger's identification card at said remote computer terminal by accessing said flight seat assignment record of an airline flight for which said passenger has a reservation;
responding to a request from said passenger, inputted through said remote computer terminal, to select a seat for said flight by causing said remote computer terminal to display seat information which identifies seats on said flight which are available for assignment;
updating said flight seat assignment record, in response to receipt of seat selection information inputted through said remote computer terminal by said passenger, to show that a selected seat has been assigned to said passenger.

24. A method of validating a reservation as defined in claim 23, wherein said seat information displayed by said remote terminal is in the form of a pattern of the airplane to be used for the airline flight with only available seat numbers provided on the pattern at the locations of the available seats.

25. A method of validating a reservation as defined in claim 23, further including the step of responding to a request, inputted through said remote computer terminal by a passenger, to relinquish a seat already assigned to that passenger, by updating seat assignment record in said central data bank to indicate that the relinquished seat is available for assignment.

26. A method of validating a reservation as defined in claim 25, further including the step of inhibiting the issuing of a boarding pass to an individual until said seat assignment record in said central data bank indicates that the individual has been assigned a seat.

27. A method of validating a reservation as defined in claim 20, wherein a passenger record in said central data bank also includes frequent flier information, for individuals who are a member of an airline frequent flier program, including a current record of frequent flier miles accumulated by the individual.

28. A method of validating a reservation as defined in claim 27, further including the steps of:
selling a product to an individual who is a member of an airline frequent flier program for a specified cost;
accessing the passenger record of the individual in said central data bank; and
debiting the current record of frequent flier miles by a number of miles equal to the specified cost of said product to pay for the product, so that the individual may purchase the product without tendering cash.

29. A method of validating a reservation as defined in claim 28, wherein said product is a beverage sold on an airplane.

30. A method of validating a reservation as defined in claim 28, wherein said product is a publication sold on an airplane.

31. A method of validating a reservation as defined in claim 28, wherein said product is food sold on an airplane.

32. A method of validating a reservation as defined in claim 27, further including the steps of:
selling a service to an individual who is a member of an airline frequent flier program for a specified cost;
accessing the passenger record of the individual in said central data bank; and
debiting the current record of frequent flier miles by a number of miles equal to the specified cost of said service to pay for the service, so that the individual may purchase the service without tendering cash.

33. A method of validating a reservation as defined in claim 32, wherein said service is providing a telephone connection between the individual while riding in an airplane and a third party located outside the airplane.

34. A method of validating a reservation as defined in claim 32, wherein said service is providing a telephone connection between the individual while riding in an airplane and a third party located in the same airplane.

35. A method of validating a reservation as defined in claim 32, wherein said service is providing a telephone connection between the individual while in the airline terminal and a third party located outside the airline terminal.

36. A method of validating a reservation as defined in claim 32, wherein said service is providing a telephone connection between the individual through the remote computer terminal at the airline terminal and a third party located outside the airline terminal.

37. A method of validating a reservation as defined in claim 32, wherein said service is providing a video display of data for viewing by the passenger at his or her seat on an airplane.

38. A method of validating a reservation as defined in claim 37, wherein said video display of data is a real-time video image of another passenger on the airplane.

39. A method of validating a reservation as defined in claim 37, wherein said video display of data is a video game.

40. A method of validating a reservation as defined in claim 39, wherein said video game is displayed simultaneously at plural seats so that at least two passengers may participate in the video game at the same time.

41. A method of validating a reservation as defined in claim 40, wherein said video game is a bingo game run by the airline.

42. A method of validating a reservation as defined in claim 40, wherein said video game is a card game.

43. A method of validating a reservation as defined in claim 40, wherein said video game is a board game.

44. A method of validating a reservation as defined in claim 32, wherein said service is providing a selected audio program to a passenger at his or her seat during an airline flight.

45. A method of validating a reservation as defined in claim 32, wherein said service is renting equipment to a passenger for use at his or her seat during an airline flight.

46. A method of validating a reservation as defined in claim 20, further including the steps of:
storing information in the central data bank indicating that the individual has checked baggage to be carried by the particular airline flight when the individual checks baggage at the airline terminal prior to boarding the airline flight;
storing information in the central data bank for each individual who boards the particular airline flight indicating that the individual has boarded; and
comparing the information in the central data bank which identifies individuals who have checked baggage for the particular airline flight with information in the central data bank which identifies individuals that have boarded the particular airline flight to determine whether any individual who has checked baggage has not boarded, before the particular airline flight departs.

47. A method of validating a reservation as defined in claim 46, further comprising the steps of:
creating in the central data bank an airline flight record which identifies all individuals holding reservations for a particular airline flight, said airline flight record further including an indication whether an individual listed for the particular airline flight has checked baggage for the flight and an indication whether said individual has boarded the flight; and
updating said airline flight record when said central data bank receives information that an individual has checked baggage and when that individual has boarded the airline flight.

48. A method of validating a reservation as defined in claim 20, further including the steps of:
reading passenger identification indicia on said boarding pass at a gate for said airline flight as said individual is boarding the flight; and
communicating said passenger identification indicia read from said boarding pass to said central data bank to store information indicating that said individual has boarded the flight.

49. A method of validating a reservation as defined in claim 48, wherein said passenger identification indicia appears on said boarding pass as printed matter and is read by an optical reader.

50. A method of validating a reservation as defined in claim 48, wherein said passenger identification indicia appears on said boarding pass as a bar code which is read by a bar code reader.

51. A method of validating a reservation as defined in claim 48, wherein said passenger identification indicia is magnetically stored on said boarding pass and is read by a magnetic reader.

52. A method of validating a reservation as defined in claim 48, wherein said passenger identification indicia is the name of the individual.

53. A method of validating a reservation as defined in claim 48, wherein said passenger identification indicia is a passenger identification number.

54. A method of validating a reservation as defined in claim 48, further including the steps of:
storing information in the central data bank indicating that the individual has checked baggage to be carried by the particular airline flight when the individual checks baggage at the airline terminal prior to boarding the airline flight; and
comparing the information in the central data bank which identifies individuals who have checked baggage for the particular airline flight with information in the central data bank which identifies individuals that have boarded the particular airline flight to determine whether any individual who has checked baggage has not boarded, before the particular airline flight departs.

55. A method of validating a reservation as defined in claim 48, wherein a passenger record in said central data bank also includes frequent flier information, for individuals who are a member of an airline frequent flier program, including a current record of frequent flier miles accumulated by the individual, and further including the step of updating the record of accumulated frequent flier miles in the passenger record of an individual when the individual boards an airline flight, as indicated by passenger identification indicia read from a boarding pass at the gate of a flight and communicated to said central data bank.

56. A method of validating a reservation as defined in claim 21, wherein said passenger record further includes message information representing a message to a passenger from a third party, and further including the step of communicating a message from a passenger record to a remote computer terminal at which a personal identification card has been read to access said passenger record.

57. A method of validating a reservation as defined in claim 56, wherein a message received at a remote computer terminal is displayed on a display screen.

58. A method of validating a reservation as defined in claim 56, wherein a message received at a remote computer terminal is printed by a printer.

59. A method of validating a reservation as defined in claim 56, wherein said message is stored in at least one of the reservation fields of said passenger record.

60. A method for validating a reservation for an airline flight, in order to eliminate the need for paper tickets, said method comprising the steps of:
making a reservation for a particular airline flight for a particular individual who has a reusable personal identification card having stored thereon identification information corresponding to the individual but no specific reservation or airline flight information;
storing reservation data, which identifies the individual and the particular airline flight for which the reservation has been made, in a reservation data storage area of a central data bank;
reading the personal identification card of the individual at a selected location in an airline terminal to verify the reservation for the particular airline flight, by accessing the reservation data stored in the central data bank, and effect automatic validation at the selected location to permit the individual to board the airline flight without requiring a paper ticket; and
issuing a boarding pass to the individual to allow the individual to board the airline flight without presenting an airline ticket after the personal identification card is read and the reservation has been verified.

61. A method of validating a reservation as defined in claim 60, wherein said personal identification card has a picture of the individual thereon.

62. A method of validating a reservation as defined in claim 60, wherein said personal identification card has a first magnetic stripe on which said identification information corresponding to the individual is stored, and a second magnetic stripe on which credit account information for a credit account of the individual is stored.

63. A method of validating a reservation as defined in claim 60, wherein said personal identification card has printed on the back thereof governmental regulations and liability information as required of Warsaw Pact countries.

64. A method of validating a reservation as defined in claim 60, wherein said personal identification card is an airline card which is issued by an airline to allow a passenger to access the airline central data bank.

65. A method of validating a reservation as defined in claim 60, wherein said personal identification card is a bank-type credit card.

66. A method of validating a reservation as defined in claim 60, wherein said personal identification card is a card issued by an airline and has a first magnetic stripe on which said identification information corresponding to the individual is stored and a second magnetic stripe on which credit account information for a credit account of the individual is stored.

67. A method of validating a reservation for an airline flight, in order to eliminate the need for paper tickets, said method comprising the steps of:
making a reservation for a particular airline flight for a particular individual through a travel agent without either the travel agent or the airline issuing an airline ticket to the individual;
receiving from the travel agent payment for the airline flight on behalf of the individual;
crediting an account of the travel agent by an amount equal to a predetermined commission as soon as payment has been received on behalf of the individual;
storing reservation data, which identifies the individual and the particular airline flight for which the reservation has been made, in a reservation data storage area of a central data bank;
transmitting personal identification information, which is obtained from the individual at a selected location of an airline terminal, to the central data bank, to verify the reservation for the particular airline flight, by accessing the reservation data stored in the central data bank, and to effect automatic validation at the selected location to permit the individual to board the airline flight without requiring an airline ticket; and
issuing a boarding pass to the individual to allow the individual to board the airline flight without presenting an airline ticket after the personal identification information has been received from the selected location and the reservation has been verified;
whereby access to airline flights can be effected without the need for issuing an airline ticket to the individual.

68. A method of validating a reservation for an airline flight, in order to eliminate the need for paper tickets, said method comprising the steps of:
making a reservation for a particular airline flight for a particular individual who has a reusable personal identification card having stored thereon identification information corresponding to the individual but no specific reservation or airline flight information;
storing reservation data, which identifies the individual and the particular airline flight for which the reservation has been made, in a reservation data storage area of a central data bank, including creating in the central data bank a passenger record for an individual who makes a reservation for an airline flight, said passenger record including the name of the individual, graphic data identifying the individual and reservation fields each relating to a respective flight for which said individual has made a flight reservation, each reservation field including information indicating a flight number, a flight departure date, a flight departure time, and a gate number for the flight
reading the personal identification card of the individual at a selected location in an airline terminal to verify the reservation for the particular airline flight, by accessing graphic data and reservation data stored in a passenger record in the central data bank, and to verify the identity of the individual who presents the card on the basis of the accessed graphic data, thereby to effect automatic validation at the selected location to permit the individual to board the airline flight without requiring a paper ticket; and
issuing a boarding pass to the individual to allow the individual to board the airline flight without presenting an airline ticket after the personal identification card is read and the reservation has been verified.

69. A method of validating a reservation as defined in claim 68, wherein said graphic data represents a photo of said individual, and further including the step of displaying the graphic data at the selected location.

70. A method of validating a reservation as defined in claim 69, wherein said personal identification card has a picture of the individual thereon.

71. A method of validating a reservation as defined in claim 68, wherein said graphic data is fingerprint identifying data of said individual, and further including the step of comparing the received graphic data with a fingerprint of the individual at the selected location.

72. A method of validating a reservation as defined in claim 68, wherein said graphic data is retina scan identifying data of said individual, and further including the steps of scanning the retina of the individual and comparing the received graphic data with data obtained by scanning the retina of the individual.

73. An airline reservation and authorization system for making a reservation for a particular individual for a particular flight and for allowing said individual to board said particular flight and to access services and purchase goods on said flight using only personal identification information, and without issuing an airline ticket to said individual, said system comprising:
a central storage for storing reservation data concerning a predetermined flight and personal information which relates a particular individual, who has made a reservation for the predetermined flight, to the stored reservation data;
an identification card for accessing reservation data from said central storage, said card comprising storage means for storing information personal to an individual to identify that individual and not information concerning an airline flight for which the individual may make a reservation;
communication units located at sites remote from said central storage at which reservation information may be accessed by airline personnel from said central storage, said communication units each comprising means for providing a telecommunication connection with said central storage to verify reservation information on site and an identification card reader for reading the magnetic means on an identification card to identify an individual to the central storage, which central storage includes means responsive to personal information received from a remote site via said telecommunication means for verifying a reservation and authorizing the identified individual to board the airline flight without requiring the individual to present an airline ticket; and
an automatic teller machine at a publicly accessible location for providing information to an individual relating to an airline flight for which said individual has a reservation, said automatic teller machine comprising a card reader, a display terminal, a telecommunication unit responsive to personal information read from an identification card for accessing flight information in said central storage relating to a flight for which the card holder has a reservation to verify that reservation and for displaying said flight information, and means for issuing a boarding pass to said individual when said reservation has been verified.

74. An airline reservation and authorization system as defined in claim 73, wherein said central storage stores frequent flier information, for individuals who are a member of an airline frequent flier program, including a record of frequent flier miles accumulated by each individual.

75. An airline reservation and authorization system as defined in claim 74, wherein at least one communication unit is located on an airplane, so that airline personnel on the airplane can access said central storage using an identification card of a passenger to transfer to said central storage a request to debit the record of frequent flier miles of said passenger in payment for goods or services offered to said passenger by the airline.

76. An airline reservation and authorization system as defined in claim 74, further including a remote computer terminal provided at a passenger seat on an airplane for use by a passenger, said remote computer terminal including a card reader for reading personal information from an identification card of a passenger and a wire-less communication unit for sending personal information read from an identification card to access said central storage to debit the frequent flier miles of the passenger for payment of services offered to said passenger by the airline.

77. An airline reservation and authorization system as defined in claim 73, wherein said publicly accessible location of said automatic teller machine is in an airline terminal.

78. An airline reservation and authorization system as defined in claim 73, wherein said publicly accessible location of said automatic teller machine is in a hotel.

79. An airline reservation and authorization system as defined in claim 73, wherein said publicly accessible location of said automatic teller machine is in a business office building.

80. An airline reservation and authorization system as defined in claim 73, wherein said automatic teller machine includes a fingerprint identification scanner.

81. An airline reservation and authorization system as defined in claim 73, wherein said automatic teller machine includes a retina scan detector.

82. An airline reservation and authorization system as defined in claim 73, wherein said communication units include a bar code reader.
